(19) United States
(12) Patent Application Publication
(10) Pub. No.: US 2026/0296121 A1
(43) Pub. Date: Oct. 1, 2026

(54) HEIGHT-ADJUSTABLE SUSPENSION SYSTEM AND METHOD OF USE THEREOF

(71) Applicant: The Braun Corporation, Winamac, IN (US)

(72) Inventors: Robert Earl Bettcher, III, Winamac, IN (US); Edward Poulos, Westfield, IN (US)

(73) Assignee: The Braun Corporation, Winamac, IN (US)

(21) Appl. No.: 19/629,955

(22) Filed: Mar. 26, 2026

Related U.S. Application Data
(60) Provisional application No. 63/778,936, filed on Mar. 27, 2025.

(51) Int. Cl. B60G 17/017

(52) U.S. Cl. CPC B60G 17/017; B60G 2204/43; B60G 2204/47

(57) ABSTRACT

An adjustable suspension system is provided for vehicles, enhancing accessibility for wheelchair users by integrating a kneel mechanism into OEM suspension assemblies. The system features a rocker link mechanism, pivotably coupled between an actuator and the vehicle's subframe or control arm, or alternatively, a pivoting pulley assembly that aligns with a chain to mitigate damaging lateral forces, enabling dynamic height adjustment with minimal modification and cost. The invention utilizes flexible or rigid connections to transmit motion, reducing stress and inefficiencies associated with prior art chain and pulley systems. The kneeling system allows the vehicle to achieve a knelt height, facilitating ramp access and complying with standards for maximum incline angles. Various configurations of flexible connections, including a slider link, provide advantages and adaptability, ensuring robust and efficient operation. This invention overcomes limitations of prior art by offering a reliable and versatile solution for modifying vehicles to meet accessibility needs.

### CROSS REFERENCE TO OTHER APPLICATIONS

This application claims priority to U.S. Provisional Patent Application No. 63/778,936, filed on Mar. 27, 2025, which is incorporated in its entirety herein.

### FIELD OF THE DISCLOSURE

The present disclosure relates generally to a passenger vehicle that has been modified to allow access by a physically limited passenger, and more particularly to a vehicle suspension height adjustment system with a novel mechanism configured to reduce or mitigate wear on the components.

### BACKGROUND

The present invention relates to vehicle suspension systems, specifically focusing on height-adjustable suspension systems designed to facilitate wheelchair accessibility. In modern Original Equipment Manufacturer (OEM) vehicles, the load-bearing structure, commonly referred to as the chassis, can vary in construction—ranging from unibody to body-on-frame designs. To support the drivetrain and suspension components, many vehicles incorporate a subframe assembly which connects these components between the wheels and chassis. Typically, such suspension assemblies include one or more control arms pivotably connected to the subframe.

In the context of one disclosed embodiment, the OEM vehicle features a lower control arm, which is connected to at least one spring device. These spring devices may encompass a variety of components known in the art, including coil springs, leaf springs, air springs, hydraulic springs, magnetic springs, torsion bars, or dampers such as shock absorbers, among others.

The primary objective of the invention is to assist in the process of modifying the vehicle to be wheelchair accessible. This typically involves extensive modification to an OEM vehicle, such as lowering at least a portion of the OEM floor to accommodate a wheelchair access device, such as a ramp or a lift, while ensuring sufficient headroom for a passenger using a wheelchair while inside the vehicle. To achieve the desired ride height (e.g., to ensure sufficient ground clearance for the lowered floor), the vehicle may be raised using a body spacer. However, raising the body complicates compliance with accessibility standards, such as those outlined by the American Disabilities Act, which stipulate that the ramp platform must not exceed a specified incline angle.

To adhere to these standards, the height of the vehicle floor relative to the ground must be adjustable when the ramp is in use. Traditional methods of achieving this include replacing the OEM suspension spring devices with adjustable alternatives, which often involve prohibitive costs and extensive modifications. Therefore, there is a pressing need for a reliable kneeling device capable of compressing the vehicle suspension effectively, thereby offering a cost-effective solution to make vehicles more accessible for wheelchair users without extensive alterations to existing suspension systems. Prior art kneeling systems attempting to meet these challenges may have reliability issues.

A first embodiment addresses these challenges by introducing a novel height-adjustable suspension system that leverages a rocker link assembly. This system offers an innovative approach to compress the suspension, ensuring compliance with accessibility standards while maintaining the structural integrity and functionality of the vehicle's existing suspension setup. The rocker link assembly may replace traditional chain systems. This innovation eliminates issues like chain breakages and enhances the system's efficiency by reducing adverse loading conditions.

A second embodiment of a kneeling system may use a rocker link assembly similar to the first embodiment. The second embodiment may completely remove the chain from the kneeling system. Instead, a first section between the actuator and the rocker link and a second section between the rocker link and the control arm may have different connections. One of the first or second sections may comprise some sort of adjustable link. The adjustable link may be a telescoping link, slider link, pivoting link, or other adjustable mechanical linkage. The other of the first or second sections may comprise a rigid link, such as a link with rod ends such as heim joints.

A third embodiment addresses reliability issues of the prior art kneeling systems by mitigating critical forces experienced by a chain routed about a stationary pulley. As the prior art kneeling system actuates the chain to kneel the suspension, the control arm moves through a multi-directional path relative to the subframe. Because the chain is connected to the control arm and the pulley is mounted in a fixed position, this arcuate movement can cause the chain's alignment with the pulley to change. This can induce an undesirable lateral, or side-loading, force on the chain. Roller chains are typically designed to articulate within a single plane, not in multiple directions or be twisted along their length. The lateral force and any resulting torsional force on the chain are loads that the chain is not designed to accommodate. Excessive or prolonged lateral and torsional forces may over-stress the chain and lead to premature failure.

A fourth embodiment may provide a simpler pivotable pulley which may be coupled to a bracket. The bracket may be freely rotatably coupled to a mounting bracket configured to fixedly couple to the vehicle.

A fifth embodiment may provide an adjustably mounted pulley. The pulley may be rotatably coupled to a bracket configured to fixedly couple to the vehicle. The bracket may have adjustable mounting points to couple to the vehicle. The adjustable mounting points may comprise at least one elongated slot. In some configurations, the elongated slot may be an arcuate slot. The elongated slot may provide that the bracket may be rotatable to a desired position before securing the bracket in place, thereby positioning the pulley in a desired orientation.

### SUMMARY OF THE EMBODIMENTS

The present application pertains to a modification for a vehicle suspension assembly that, in its original equipment manufacturer (OEM) configuration, comprises a suspension system integrated with a vehicle structure. The modification to the OEM vehicle suspension may be required for making the vehicle accessible for wheelchaired passengers. The vehicle may be modified to provide wheelchair access by adding a wheelchair ramp. The wheelchair ramp may have a maximum ramp incline angle, defined by one or more standards including the American Disabilities Act (ADA). The OEM vehicle may be a unibody construction, body-on-frame construction, or any other known vehicle construction. The vehicle may include a frame, or subframe, and a control arm. Hereinafter, any reference made to the subframe may include a subframe structure in a unibody construction vehicle, or the subframe may be referring to the frame in a body-on-frame construction vehicle. A control arm may be pivotably connected adjacent one end to the subframe and adjacent the other end to a wheel. An OEM vehicle suspension may include a single control arm, or multiple control arms, in some cases an upper control arm and a lower control arm. Hereinafter, the control arm may refer to a single-control arm configuration, or either of the upper and lower control arms in a two-control arm configuration. A spring device, which may include at least one of a coil spring, leaf spring, air spring, hydraulic spring, or torsion bar, is coupled between the control arm and the subframe or the chassis, providing the necessary support and cushioning for the vehicle's ride. This conventional setup does not include any mechanism for adjusting the suspension height dynamically to assist with accessibility features. There are known methods for modifying OEM suspension assemblies to include height-adjustment, such as replacing the spring device with an adjustable airbag or hydraulic suspension device, but this method is often high cost and requires extensive modification.

In contrast, prior art solutions have attempted to incorporate a cost-effective and simple modification kneel system into the OEM vehicle suspension assembly to facilitate accessibility for wheelchair users. These systems typically involve an actuator fixed to the subframe with a moveable rod coupled to an end of a chain that is routed around a pulley. The chain may then be coupled to the control arm at the opposite end of the chain. The actuator, when activated, pulls the chain, causing a force on the control arm that compresses the suspension system. However, such configurations often suffer from issues like chain breakages due to adverse loading conditions and are prone to inefficiencies and maintenance challenges.

A first embodiment of the invention disclosed herein addresses the shortcomings of prior art by providing an adjustable suspension system with an integrated kneel mechanism that enhances the vehicle's functionality and reliability. This system includes a kneel system that may include a rocker link with a central pivot point coupled (directly or indirectly) to either the subframe or the control arm. The modifications to the OEM vehicle may include a body spacer to lift the body to a higher elevation than the OEM configuration. The body spacer may be coupled to the vehicle between the vehicle body and the subframe. The rocker link may be pivotably coupled at the central pivot point to the body spacer bracket (which provides an indirect coupling between the rocker link and the subframe). The rocker link may be pivotably connected between a moveable rod of an actuator and one of the subframe or the control arm. This rocker link may allow for a more robust and efficient height adjustment mechanism than the pulley and chain design of the prior art.

In one example of the first embodiment, the actuator may be coupled to the subframe. The rocker link may further comprise a secondary pivot point, which may be offset from the central pivot point by a distance, enabling precise control over the kneeling action. The moveable rod of the actuator may be coupled to this secondary pivot point.

In a further example of this embodiment, the rocker link may include a tertiary pivot point, which may be pivotably coupled to a link at a first end of the link. A second end of the link may be pivotably coupled to the control arm.

In an alternative example of this embodiment, the actuator may be coupled between the control arm and the tertiary pivot point of the rocker link. In this embodiment, the link may be pivotably coupled to the secondary pivot point of the rocker link at a first end of the link, and pivotably coupled to the subframe at a second end of the link.

In an example of any of the previous examples of the first embodiment, the moveable rod of the actuator may be coupled to the rocker link via tensile members, which can be a chain, cable, rope, or a telescoping link. A second embodiment may utilize the telescoping link may comprise a first rod with a channel that accommodates a second rod. The channel of the first rod may have a narrowing portion configured to prevent sliding motion of the second rod past a predetermined position. The second rod may have a protruding feature at an end of the second rod configured to engage with the narrowing portion of the channel of the first rod.

In a further example of the previous examples, the moveable rod of the actuator may be coupled to the rocker link via a rigid link, and the rocker link may be coupled to either the control arm or the subframe via a tensile member.

Any combination of the connection between the rocker link and the subframe and the rocker link and the control arm may be a tensile member. The tensile member may be required such that during vehicle operation, the spring device of the OEM suspension may compress when hitting an obstacle such as a bump without rigidly transferring that compression to the actuator to damage the internals of the actuator.

The actuator, which may be a linear actuator, hydraulic cylinder, or pneumatic cylinder, is adaptable for coupling to either the subframe or the control arm, offering versatility in installation and operation. This inventive configuration ensures a reliable and efficient height adjustment system that overcomes the limitations of prior solutions, enhancing accessibility and functionality for modified vehicles.

In a third embodiment, the lateral forces applied to the chain which may result in torsional forces experienced by the chain in prior art kneeling systems may be mitigated by a pivoting pulley assembly. The assembly may comprise a pulley, roller, gear, sprocket, or other similar rotating element that may be rotatably coupled to a pivotable bracket. The pivotable bracket may be pivotably coupled to a fixed structure on the vehicle, such as a body-spacer or component of the OEM vehicle suspension such as a subframe. Alternative connection points such as to a frame of a body-on-frame vehicle or to the body of a unibody vehicle are contemplated herein. The pivotable bracket may be pivotable about an axis that is substantially coaxial with a centerline of the chain segment extending between the pulley and an actuator. This allows the pulley assembly to self-align with the chain as the suspension moves, thereby reducing lateral and torsional forces on the chain.

In a fourth embodiment, a simpler pivotable pulley is provided which may be coupled to a bracket. The bracket may be rotatably coupled to a mounting bracket configured to fixedly couple to the vehicle. The bracket may be rotatably coupled via a bearing and may be free to rotate in response to the forces experienced by the chain.

In a fifth embodiment, an adjustably mountable pulley assembly may be coupled in a position in which the lateral forces applied to the chain which may result in torsional forces experienced by the chain in prior art kneeling systems may be mitigated. The pulley may be rotatably coupled to a bracket. The bracket may be securely mountable to a rigid member of the vehicle or aftermarket components, such as a body spacer. The bracket may contain one or more elongated apertures for receiving a fastener to secure to the body spacer. In a specific example, the one or more elongated apertures may be arcuate slots such that the bracket may be rotatable relative to the body spacer when coupling the bracket to the body spacer. In a further specific example, the bracket may have two elongated apertures. The assembly may further comprise one or more clamping brackets for the fastener to distribute the clamping force on the bracket around the one or more elongated members when secured to the bracket.

In a first installation method of the fifth embodiment, the adjustably mountable pulley assembly may be loosely fastened to the body spacer. A light source, such as a laser may then be temporarily affixed to the bracket. Once loosely secured, the bracket may be pivoted relative to the body spacer until the light source points at a specified point on the control arm. In a further example of this installation method, a target may be temporarily affixed to the control arm to accurately aim the light source. Once the light source is pointed in the correct direction, the fasteners may be secured to fix the bracket to the body, locking the pulley in position.

In a second installation method of the fifth embodiment, the adjustably mountable pulley assembly may be snugly fastened to the body spacer such that the bracket is pivotable with force. The chain may be installed between an actuator and the control arm and routed over the pulley between the actuator and control arm. The actuator may then be operated for a predetermined number of cycles retracting and releasing the chain. The lateral forces experienced by the chain may be transferred to the pulley, which may then pivot the bracket relative to the body spacer. The pulley may self-align to an ideal position for the chain forces. After the cycles are complete, the fasteners may be secured, locking the bracket in that ideal position.

This summary captures the progression from traditional suspension systems, through prior art attempts, to the innovative solution presented in the new set of claims, highlighting key components and their interactions within the invention.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a perspective view of a prior art kneeling system installed on an OEM subframe of a vehicle.

FIG. 2 is a perspective view of a first new kneeling system installed on an OEM subframe of a vehicle.

FIG. 3 is a rear view of the new kneeling system of FIG. 2 installed on an OEM subframe of a vehicle at a riding height.

FIG. 4 is a rear view of the new kneeling system of FIGS. 2-3 installed on an OEM subframe of a vehicle at a knelt height.

FIG. 5 is a perspective view of a second new kneeling system installed on an OEM subframe of a vehicle.

FIG. 6 is a rear view of the new kneeling system of FIG. 5 installed on an OEM subframe of a vehicle at a riding height.

FIG. 7 is a rear view of the new kneeling system of FIGS. 5-6 installed on an OEM subframe of a vehicle at a knelt height.

FIG. 8 is an assembly view of the new kneeling system of FIGS. 5-7.

FIG. 9 is a rear view of the linkage of the new kneeling system of FIGS. 5-8.

FIG. 10 is a rear view of an alternative linkage of the kneeling system.

FIG. 11 is a top view of an alternative linkage of the kneeling system.

FIG. 12 is a rear view of the alternative linkage of FIG. 11.

FIG. 13 is a rear view of an alternative linkage of the kneeling system.

FIG. 14 is perspective view of a third new kneeling system installed on an OEM subframe of a vehicle.

FIG. 15 is a perspective view of the new kneeling system of FIG. 14 isolated from the OEM subframe of the vehicle.

FIG. 16 is a perspective view of a fourth new kneeling system.

FIG. 17 is a perspective view of a fifth new kneeling system installed on an OEM subframe of a vehicle.

FIG. 18 is a perspective view of the new kneeling system of FIG. 17 isolated from the OEM subframe of the vehicle.

FIG. 19 is an assembly view of the new kneeling system of FIGS. 17-18.

Corresponding reference numerals are used to indicate corresponding parts throughout the several views.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

The present invention relates to an adjustable suspension system designed to enhance vehicle accessibility, particularly for wheelchair users. This system integrates a kneel mechanism into the existing OEM suspension assembly, enabling dynamic height adjustment with minimal modification and cost.

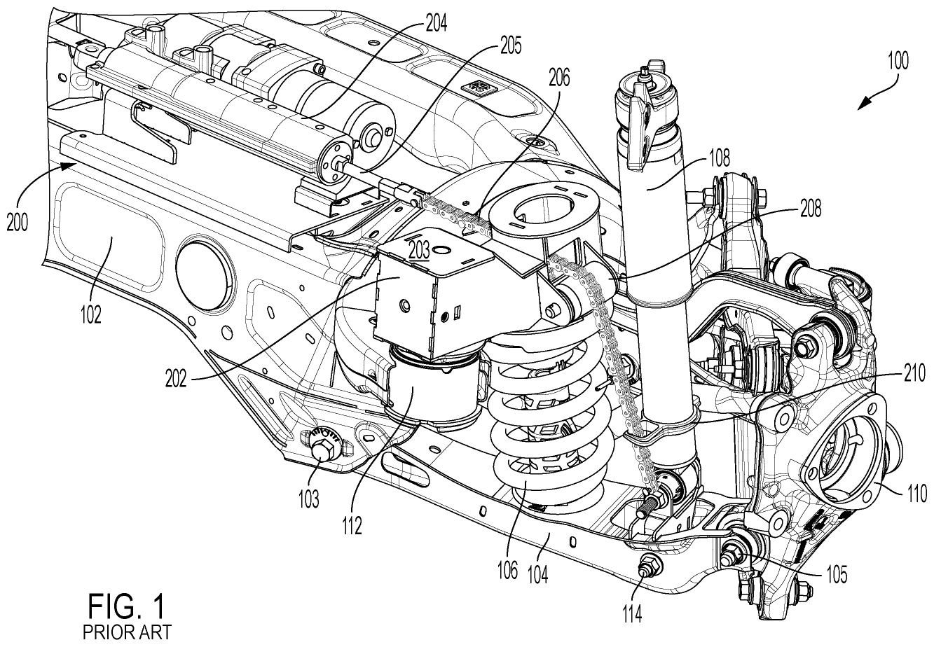

Referring to FIG. 1, a prior art kneeling system 200 installed in an OEM suspension assembly 100 is depicted. The OEM suspension assembly 100 may be a suspension assembly for a rear axle of a vehicle or a front axle of a vehicle. In the illustrative embodiment, the OEM suspension assembly 100 is a rear axle suspension assembly. The OEM suspension assembly 100 may include a subframe 102. In the illustrative embodiment, the subframe 102 may be coupled to a body of a vehicle having a unibody construction. In other vehicle constructions such as a body on frame construction, the subframe 102 may be a frame of the vehicle. A first end 103 of a control arm 104 may be pivotably coupled to the subframe 102. A second end 105 of the control arm 104 may couple to a knuckle 110 configured to couple to a wheel of the vehicle. In the illustrative embodiment, the OEM suspension assembly 100 may only include the single control arm 104 which may be described as a lower control arm as it is mounted to a lower point on the knuckle 110 than axis of rotation of a wheel mounted to the knuckle 110. It is contemplated that the prior art kneeling system 200, and the improved kneeling system 300 described below may be installed in an OEM suspension assembly 100 having a single control arm being described as an upper control arm mounted to a higher point on the knuckle than the axis of rotation of a wheel mounted to the knuckle 110. It is further contemplated that the prior art kneeling system 200, and the improved kneeling system 300 described below may be installed in an OEM suspension assembly 100 having two or more control arms. In a two-control arm configuration, the OEM suspension assembly 100 may have each of an upper and a lower control arm. It is contemplated that the prior art kneeling system 200 and the improved kneeling system 300 may engage and be configured to actuate any control arm in an OEM suspension assembly 100 configuration.

The control arm 104 may be coupled with one or more spring devices configured to support the vehicle and cushion the ride during vehicle operations when encountering obstacles such as a bump or a pothole. The OEM suspension assembly 100 may have a first spring device 106, illustrated as a coil spring, and a second spring device 108 illustrated as a shock absorber. The second spring device 108 may be pivotably coupled to the control arm 104 at a connection 114. The subframe 102 may further comprise an OEM body mounting point 112 for the subframe 102 to be coupled to the body of the vehicle.

The OEM suspension assembly 100 has been modified from OEM configuration to include a kneeling system 200. The OEM suspension assembly 100 may further be modified with a body spacer 202 configured to elevate the body of the vehicle with respect to the subframe 102. The body spacer 202 may be coupled to the subframe 102 at the OEM body mounting point 112 and to the first spring device 106. The body spacer 202 may be coupled between the OEM body mounting point 112 and the body of the vehicle, and between the first spring device 106 and the body of the vehicle. The body spacer 202 may have a top surface 203 configured to be coupled to the body of the vehicle.

The kneeling system 200 may include an actuator 204 with a moveable rod 205 configured to operate the kneeling system 200 to compress the OEM suspension assembly 100 from a ride height to a knelt height. As shown, the moveable rod 205 is extended, whereby the suspension assembly 100 is shown at a ride height. The movable rod 205 of the actuator may be connected to a chain 206 routed around a pulley 208 pivotably coupled to the body spacer 202 and through a guide 210 coupled to the shock absorber 108. The chain 206 may then be coupled to the control arm 104 at the second spring device 108 connection point 114, however, any other connection point on the control arm 104 is contemplated. This prior art kneeling system 200 configuration may be cost-effective, but may suffer from chain 206 breakages, stretching, rattling, and inefficiencies due to adverse loading conditions.

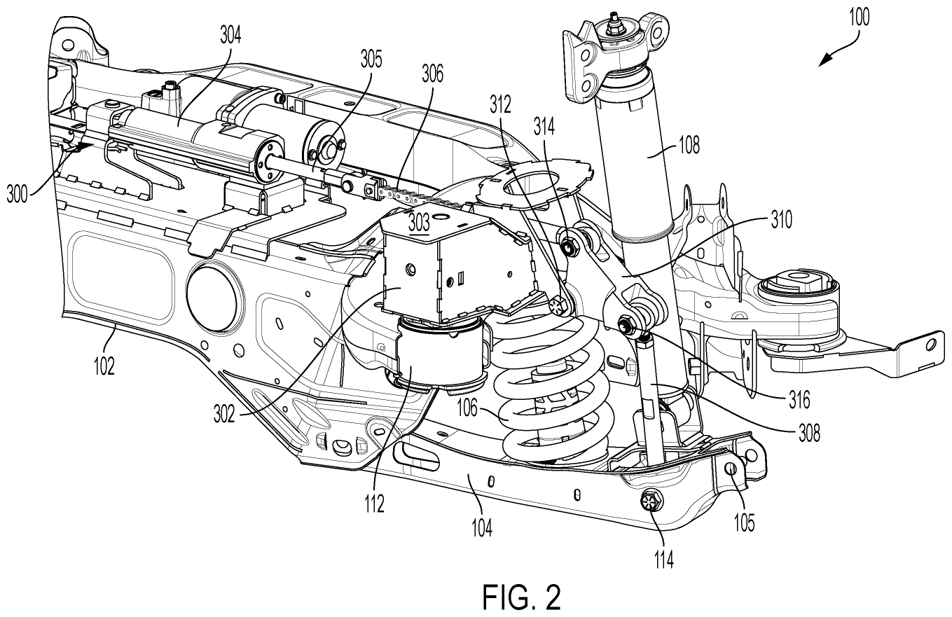

FIGS. 2-4 illustrate a first new kneeling system 300, installed on OEM suspension assembly 100. Similar to the prior art kneeling system 200, the new kneeling system 300 may include a body spacer 302, which may be configured to elevate the body of the vehicle with respect to the subframe 102. The body spacer 302 may be coupled to the subframe 102 at the OEM body mounting point 112 and to the first spring device 106. The body spacer 302 may be coupled between the OEM body mounting point 112 and the body of the vehicle, and between the first spring device 106 and the body of the vehicle. The body spacer 302 may have a top surface 303 configured to be coupled to the body of the vehicle.

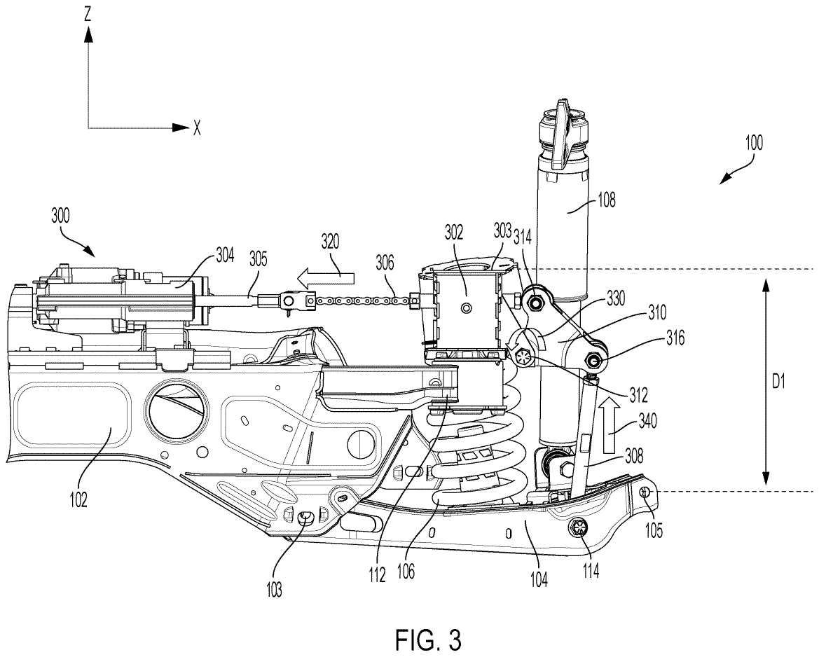

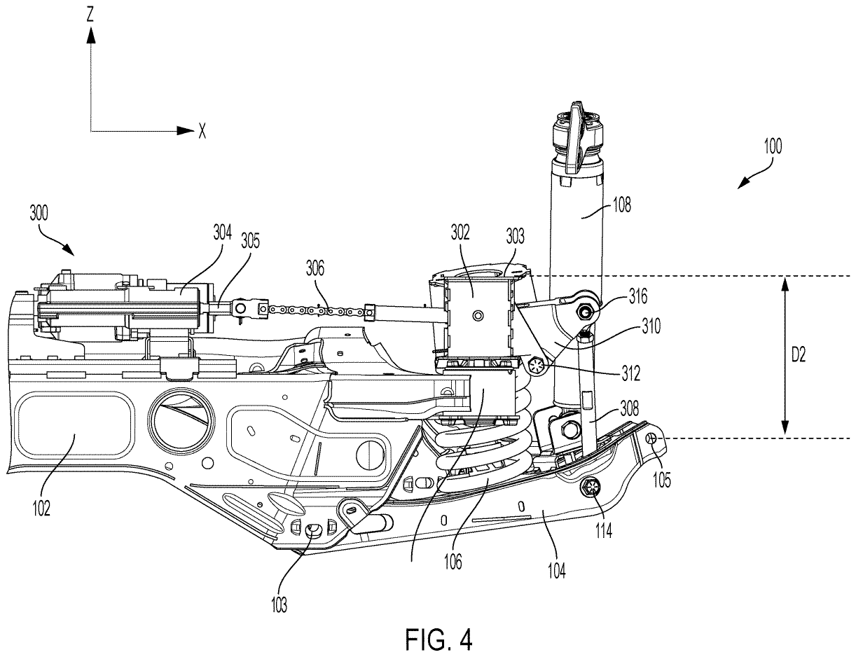

In the exemplary embodiment of FIGS. 2-4, the new kneeling system 300 may include an actuator 304 coupled to the subframe 102. The actuator 304 is shown directly coupled to the subframe 102, but indirect connections are contemplated, such as mounting the actuator to the vehicle body. The actuator 304 may have a moveable rod 305 configured to operate the kneeling system 300 to compress the OEM suspension assembly 100 from a ride height D1 illustrated in FIG. 3, and to a knelt height D2 illustrated in FIG. 4. The new kneeling system 300 may also comprise a rocker link 310 which may have a central pivot point 312 pivotably coupled to the body spacer 302. The central pivot point 312 is shown directly coupled to the body spacer 302, but indirect connections are contemplates, such as mounting the central pivot point 312 to the subframe 102 or vehicle body. The rocker link 310 may also be pivotably connected at a secondary pivot point 314 to the moveable rod 305 of the actuator 304 and at a tertiary pivot point 316 to the control arm 104, whereby rotation of the rocker link 310 about the central pivot point 312 transfers motion from the actuator 304 to the control arm 104 to compress the OEM suspension assembly 100. While it is contemplated that the rocker link 310 may be directly coupled between the moveable rod 305 and the control arm 104, the rocker link 310 is shown coupled to the moveable rod 305 via a tensile member 306 and to the control arm 104 via link 308. The tensile member 306 is configured at a minimum to resist tensile forces but may also be configured resist compressive forces. In one embodiment, the tensile member 306 may be a flexible member that does not resist compressive forces, such as the illustrated chain. It is alternatively contemplated to use other flexible members such as a cable or a rope.

In an alternative embodiment, the locations of certain components may be swapped, whereby the actuator 304 may be coupled between the rocker link 310 and the control arm 104, and the link 308 may be coupled between the rocker link 310 and the subframe 102. In another alternative embodiment, the actuator 304 may be coupled between the rocker link 310 and the control arm 104, and the link 308 may be eliminated. In another alternative embodiment, the layout of the new kneeling system 300 may be reversed, whereby the actuator 304 may be coupled to the control arm 104 and the rocker link 310 may be coupled at its central pivot point 312 to the control arm 104, at its secondary pivot point 314 to the moveable rod 305 of the actuator 304, and at its tertiary pivot point 316 to the subframe 102. In another alternative embodiment, the rocker link 310 may be coupled at its central pivot point 312 to the control arm 104, the actuator 304 may be coupled between the rocker link 310 and the subframe 102, and the link 308 may be eliminated.

With specific reference to FIG. 3, the new kneeling system 300 may be relaxed in a disengaged position such that the OEM suspension assembly 100 may be at a riding height D1, illustrated here as a vertical distance between the top surface 303 of the body spacer 302 and the end 105 of the control arm 104 where a knuckle would be coupled to the control arm 104 and to a wheel. The relaxed kneeling system 300 may be mounted in such a manner that it may maintain the OEM vehicle's standard suspension height and travel. By configuring tensile member 306 such that it does not resist compressive forces, the control arm 104 retains its normal range of motion as the vehicle navigates rough terrain, bumps, and potholes. To kneel the OEM suspension assembly 100, the actuator 304 may exert a pulling force on the moveable rod 305, and therefore the tensile member 306, substantially in the direction of arrow 320. The flexible connection 306 may transfer this force/movement to the rocker link 310 at the secondary pivot point 314. The offset distance between the central pivot point 312 and the secondary pivot point 314 of the rocker link 310 may cause a torque to induce rotation of the rocker link 310 about the central pivot point 312 substantially correlating to arrow 330. The offset distance between the central pivot point 312 and the tertiary pivot point 316 of the rocker link 310 may then transfer the torque/rotation to the link 308 via tertiary pivot point 316 and exert a pulling force on the link 308 substantially in the direction of arrow 340. The movement of the kneeling system 300 may compress the first and second spring devices 106, 108 of the OEM suspension assembly 100 to a knelt height D2, best seen in FIG. 4.

FIG. 4 demonstrates the kneeling system 300 at an engaged position to move the OEM vehicle suspension assembly 100 to a knelt height D2. The knelt height D2 may be less than the riding height D1 by a desired amount, which may reduce the height of a vehicle interior floor relative to ground to facilitate ramp access for wheelchaired passengers. The knelt height D2 may be sufficiently low enough to meet the ADA standards for maximum wheelchair ramp deployment incline angle.

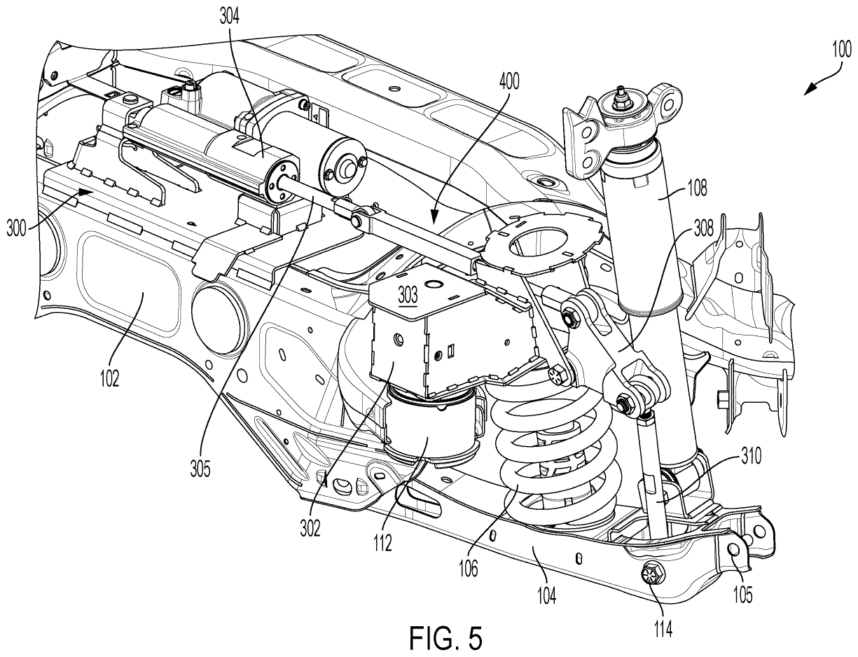

FIG. 5-9 illustrates various views of the OEM suspension assembly 100 with a second new kneeling system 300 installed and introduces an alternative design that swaps out tensile member 306 with a telescoping member 400 coupled between the moveable rod 305 of the actuator 304 and the secondary pivot point 314 of rocker link 310. Telescoping member 400 is a tensile member, in that it is configured to resist tensile forces but no compressive forces. When compressive forces act on the telescoping member 400, it shortens by “telescoping.” The embodiment of FIG. 5 is otherwise substantively identical to the embodiment of FIGS. 2-4. In alternative embodiments, it is contemplated that a rigid link such as link 308 may be coupled between the moveable rod 305 of the actuator 304 and the secondary pivot point 314 of the rocker link 314, and that the telescoping member 400 may be coupled between the tertiary pivot point 316 of the rocker link 310 and the control arm 104.

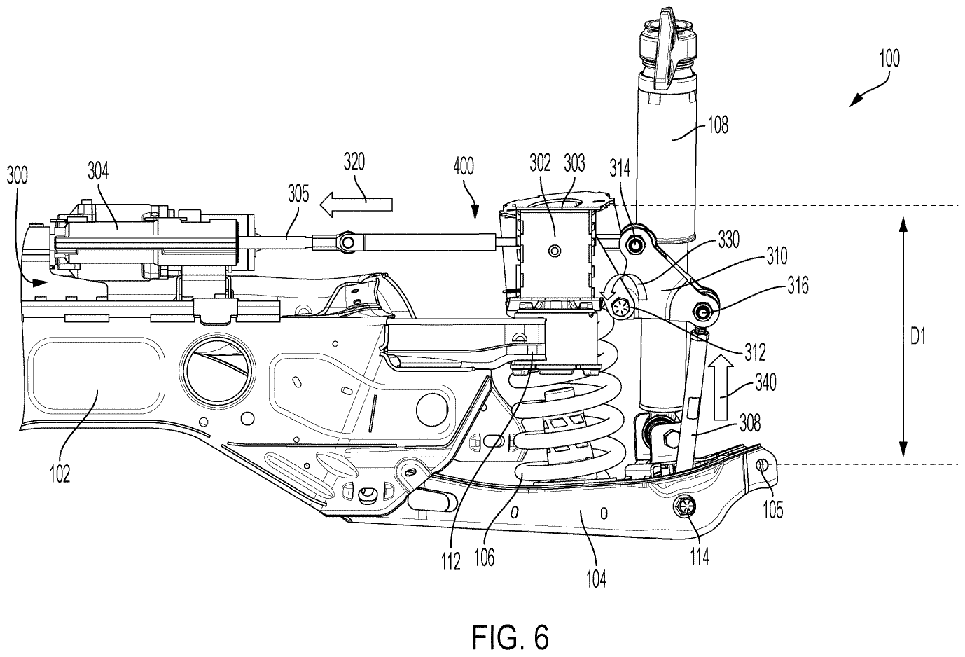

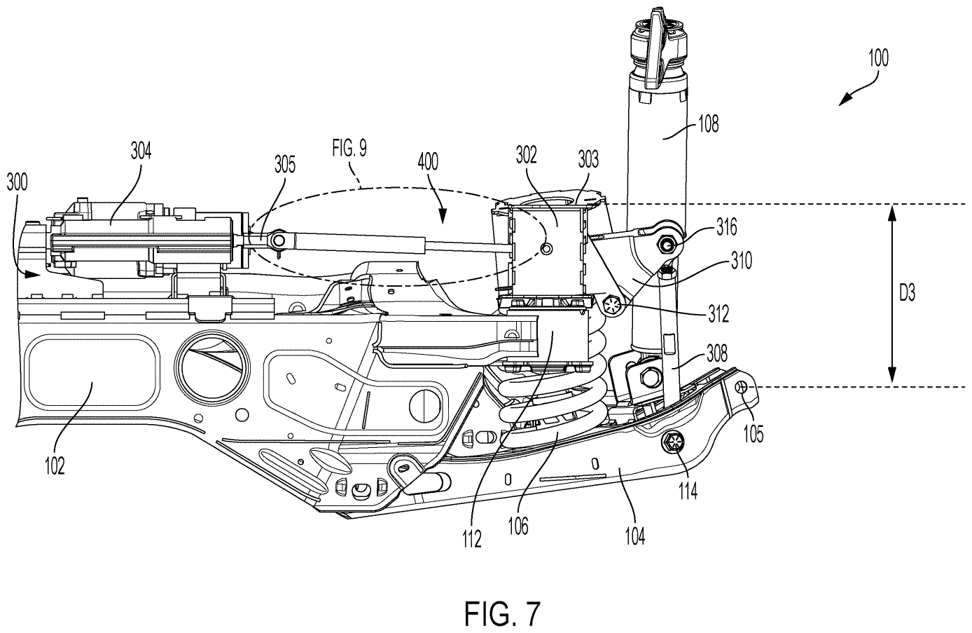

FIG. 6 illustrates a rear view of the OEM suspension assembly 100 with the kneeling system 300 installed and in a disengaged position. The OEM suspension assembly 100 is at a ride height D1 between the top surface 303 of the body spacer 302 and the end 105 of the control arm 104 configured to connect to a knuckle to couple a wheel. To kneel the OEM suspension assembly 100, the actuator 304 may exert a pulling force on the moveable rod 305, and therefore the telescoping member 400, substantially in the direction of arrow 320. The telescoping member 400 may transfer this force/movement to the rocker link 310 at the secondary pivot point 314. The offset distance between the central pivot point 312 and the secondary pivot point 314 of the rocker link 310 may cause a torque to induce rotation of the rocker link 310 about the central pivot point 312 substantially correlating to arrow 330. The offset distance between the central pivot point 312 and the tertiary pivot point 316 of rocker link 310 may then transfer the torque/rotation to the link 308 via tertiary pivot point 316 and exert a pulling force on the drop link 308 substantially in the direction of arrow 340. The movement of the kneeling system 300 may compress the first and second spring devices 106, 108 of the OEM suspension assembly 100 to a knelt height D3, as best shown in FIG. 7, which may be the same or different from knelt height D2 of the embodiment shown in FIG. 4.

FIG. 7 demonstrates the kneeling system 300 at an engaged position to move the OEM vehicle suspension assembly 100 to a knelt height D3. The knelt height D3 may be less than the riding height D1 by a desired amount, which may reduce the height of the ground to a vehicle interior floor to facilitate ramp access for wheelchaired passengers. The knelt height D3 may be sufficiently low enough to meet the ADA standards for maximum wheelchair ramp deployment incline angle.

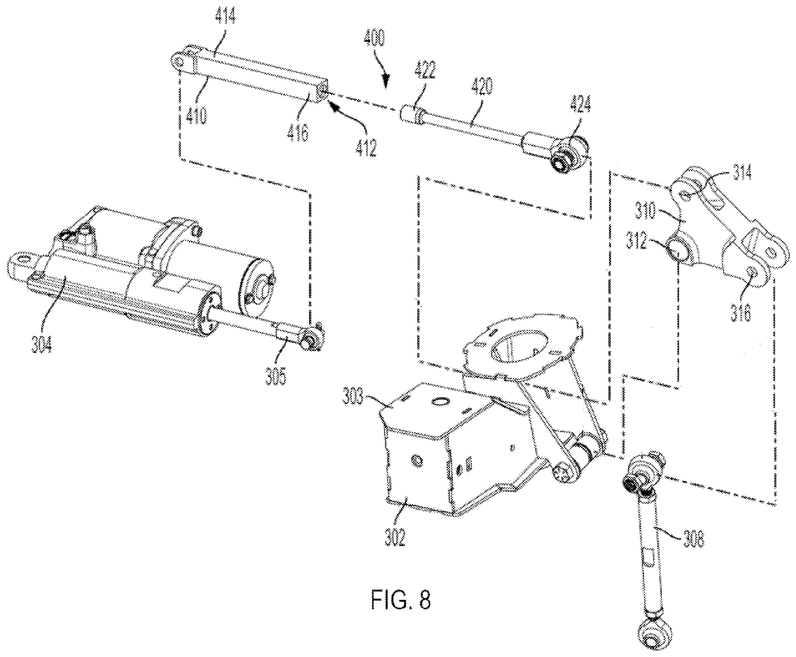

FIG. 8 illustrates an exploded assembly view of the kneeling system 300, in particular the connection between the moveable rod 305 of the actuator 304 and the secondary pivot point 314 of the rocker link 310 via the telescoping member 400. The telescoping member 400 may be described as a sliding mechanism that may be constructed of at least a first rod 410 and a second rod 420. The first rod 410 may couple to the moveable rod 305 of the actuator 304 at a first end 414 of the first rod 410. The second end 424 of the second rod 420 may be pivotably coupled to the secondary pivot point 314 of the rocker link 310. The first rod 410 may additionally comprise a hollow channel 412 along the length of the first rod 410, with an opening to the hollow channel 412 being disposed at the second end 416 of the first rod 410. The hollow channel 412 may be configured to receive the second rod 420. The second rod 420 may have a protruding end 422 configured to linearly slide along the channel 412 of the first rod 410. The hollow channel 412 may include a lip or other stop at the second end 416 of the first rod 410 that engages with the protruding end 422 to hold the first and second rods 410, 420 engaged With the protruding end 422 engaged with the stop, the telescoping member 400 can effectively resist tensile forces. When compressive forces act on the telescoping member 400, the first and second rods 410, 420 telescope and shorten in length, with the protruding end 422 sliding within the channel 412 toward the first end 414 of the first rod 410.

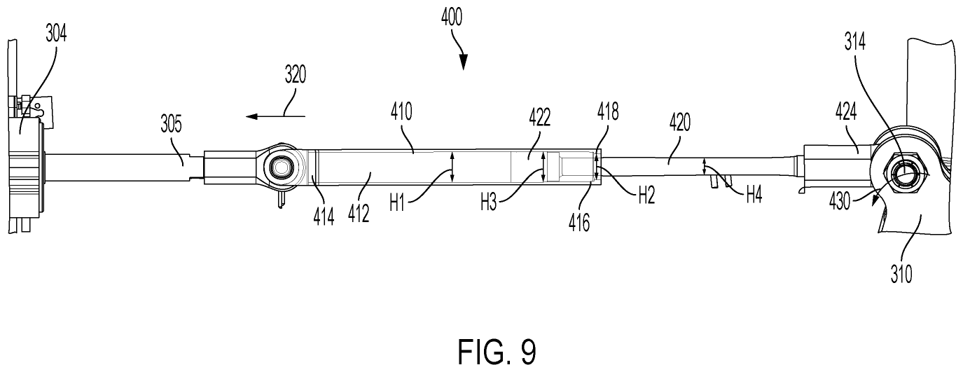

FIG. 9 illustrates a rear view of the telescoping link 400, with the first rod 410 in a semi-transparent representation to illustrate the internals of the channel 412. The channel 412 of the first rod 410 and the second rod 420 may have substantially circular cross-sectional designs, however, any geometrical cross-section is contemplated as long as the two rods 410, 420 substantially correlate to create proper engagement. Herein, the disclosure will be describing the current rear view of the system, only calling out the height of the features of the first and second rods 410, 420, but the width may also be adjusted similar to the heights in non-symmetrical cross-section designs. The channel 412 of the first rod 410 may have a first height of H1. At the second end 416 of the first rod 410, there may be a narrowing feature 418. The narrowing feature 418 may have a second height H2. The protruding end 422 of the second rod 420 may have a third height H3, while the rest of the second rod 420 may have a fourth height H4. The second rod 420 height H4 may be less than the first rod 410 height H2 such that the second rod 420 may freely slide relative to the first rod 410. The protruding end 422 height H3 may be greater than the first rod 410 height H2 such that the protruding end 422 may not travel passed the narrowing feature 418. The channel 412 height H1 may be greater than the protruding end 422 height H3 such that the protruding end 422 may freely slide relative to the first rod 410.

Any of the channel 412, the protruding end 422, the second rod 420 may be constructed of low friction material such as UHMW such that the first and second rods 410, 420 engage with a tight slip fit to reduce rattling of the telescoping member 400 during vehicle operation. Alternatively, the first and second rods 410, 420 may be a loose slip fit. The looser fit may assist to accommodate misalignment as the moveable rod 305 of the actuator 304 pulls on the telescoping member 400. After the narrowing feature 418 engages the protruding end 422 of the second rod 420 and the second rod 420 pulls the rocker link 310 at the secondary pivot point 314 to induce rotation of the rocker link 310 substantially in the direction of arrow 330, the secondary pivot point 314 may move along a radiused arc around the central pivot point 312. This may substantially correlate to the arrow 430 in FIG. 9. As the secondary pivot point 314 rotates along that arc path, the secondary pivot point 314 may move in a downward direction in this rear view of FIG. 9. This motion may result in the movable rod 305 of the actuator 304 not pulling in a substantially horizonal path, which may stress the internals of the actuator. A loose fit between the first and second rods 410, 420 may ease this stress.

It is additionally contemplated that the first and second rods 410, 420 may be switched positions such that the first end 414 of the first rod is pivotably coupled to the secondary pivot point 314 of the rocker link 310 and the second end 424 of the second rod 420 is coupled to the moveable rod 305 of the actuator 304.

During the kneeling process, the actuator 304 may pull the moveable rod 305 and therefore the first rod 410 in a direction substantially along arrow 320. The first rod 410 may move along arrow 320 until the narrowing feature 418 engages with the protruding end 422 of the second rod 420. This engagement may induce movement of the second rod 420 which may transfer the kneeling movement to the rocker link 310, which may compress the OEM suspension assembly 100 and kneel the vehicle.

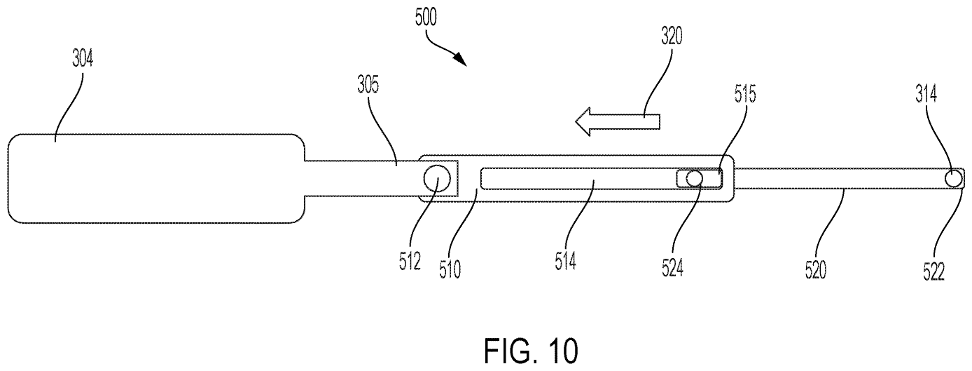

Other common link mechanisms are contemplated herein to replace the telescoping member 400. FIGS. 10-13 illustrate additional examples for a telescoping member 500. FIG. 10 is a rear view of the telescoping member 500 which may comprise a first rod 510 that may be pivotably coupled to the movable rod 305 of the actuator 304. Like the telescoping member 400, the first rod 510 may include a channel configured to receive the second rod 520. The first rod 510 may have a slot 514 configured to receive a pin 524 of a second rod 520. The pin 524 may alternatively be a bolt or any other known device in the art, and may be configured to slide along a slot 514 in the first rod 510. A second end 522 of the second rod 520 may be pivotably coupled to the secondary pivot point 314 of the rocker link 310. The actuator 304 may exert a pulling force substantially along arrow 320, and an end 515 of the slot 514 may provide a stop for the pin 524 to engage such that the first and second rods 510, 520 may transfer the force to the rocker link 310 to kneel the vehicle. In an alternative configuration, the second rod 520 may include a slot and the first rod 510 may have a pin configured to engage the slot of the second rod 520.

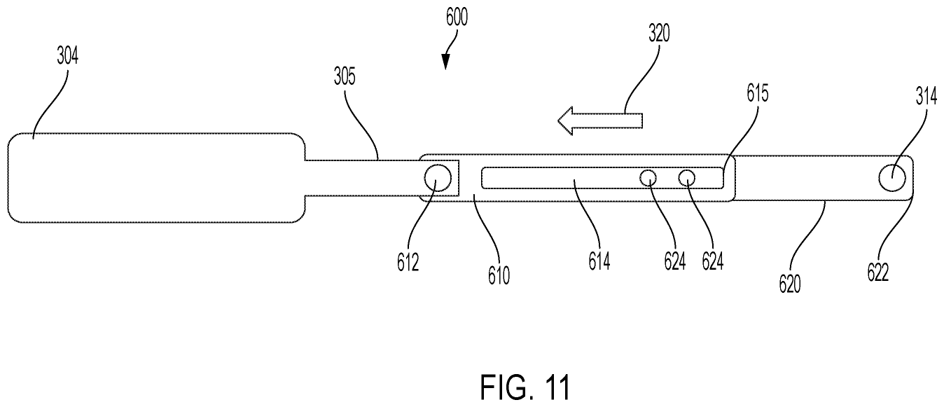

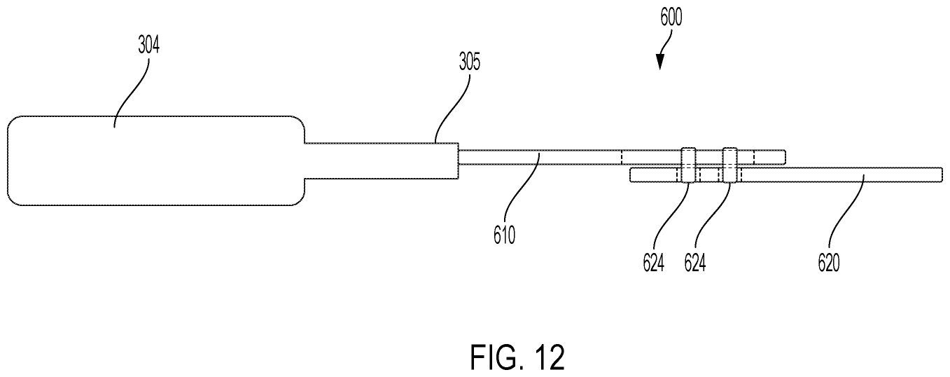

FIG. 11-12 illustrates a top view of a telescoping member 600 which may comprise a first plate 610 pivotably coupled to the moveable rod 305 of the actuator 304 at a first end 612 of the first plate 610. The first plate 610 may be disposed in over- or under-lying relation with respect to a second plate 620. The first plate 610 may include a slot 610 configured to receive one or more pins 624 of the second plate 620. The second plate 620 may be pivotably coupled to the secondary pivot point 314 of the rocker link 310 at a second end 622 of the second link 620. The actuator 304 may exert a pulling force substantially along arrow 320, and an end 615 of the slot 610 may provide a stop for the one or more pins 624 to engage such that the first and second plates 610, 620 may transfer the force to the rocker link 310 to kneel the vehicle. In an alternative configuration, the second plate 620 may include a slot and the first plate 610 may have one or more pins configured to engage the slot of the second rod 520.

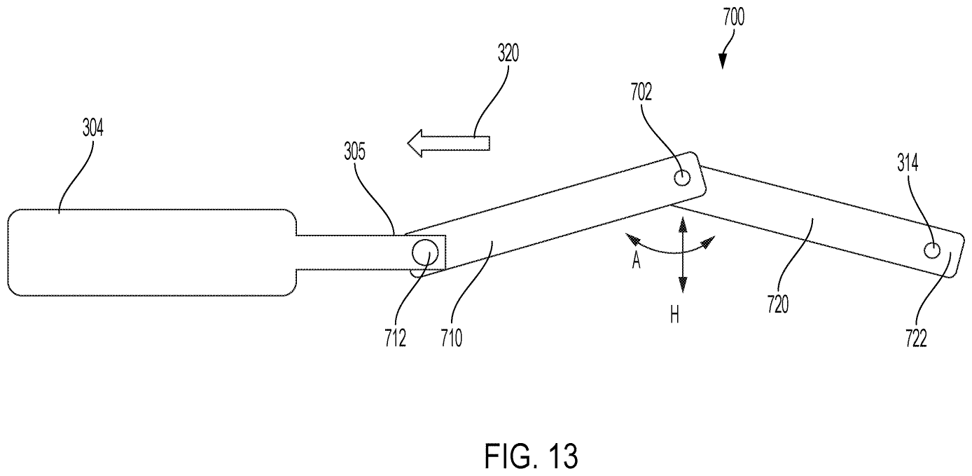

FIG. 13 illustrates a rear view of a link mechanism 700 which may include a first link 710 and a second link 720 which may be pivotably coupled together at a pivot point 702 such that they may be free to rotate relative to each other. The first link 710 may be pivotably coupled to the moveable rod 305 of the actuator 304 at a first end 712 of the first link 710. The second link 720 may be pivotably coupled to the secondary pivot point 314 of the rocker link 310 at a second end 722 of the second link 720. The first and second links 710, 720 may be in a relaxed or disengaged position wherein an angle A may be defined between the first and second links 710, 720. The actuator 304 may exert a pulling force substantially along arrow 320 on the first link 710, causing the first and second links 710, 720 to rotate until the angle A is substantially 180 degrees, at which point the first and second links 710, 720 may transfer the force to the rocker link 310 to kneel the vehicle. During the transition from the relaxed to the engaged position, the angle A may increase, but the elevation H of the pivot point 702 may also change. In the illustrative embodiment, the pivot point 702 is at a higher elevation H in the relaxed position and moves downwards as the first and second links 710, 720 rotate to the engaged position. In an alternative configuration, the pivot point 702 may be at a lower elevation H in the relaxed position such that rotation of the first and second links 710, 720 to the engaged position may move the pivot point 702 upwards along H.

The actuator 304 may be a linear (electro-mechanical) actuator, hydraulic cylinder, pneumatic cylinder, a winch, or any other known system in the art, offering versatility in installation. This adaptability ensures a reliable and efficient height adjustment system, overcoming limitations of prior solutions while enhancing vehicle accessibility and functionality.

Deficiencies in the prior art arise from the movement of the underlying suspension components. The prior art kneeling system 200, shown in FIG. 1, utilizes a chain 206 and a fixed pulley 208. While the inventive embodiments described in reference to FIGS. 3 and 4 replace or modify this mechanism, they are typically installed on the same fundamental OEM suspension assembly 100, which includes the subframe 102 and the control arm 104. Consequently, the path of the control arm 104 during kneeling is substantially identical in both the prior art kneeling system 200 and inventive systems described herein. The rear views of the suspension shown in FIGS. 3 and 4, while illustrating an inventive kneeling system, are used in the following discussion because they clearly depict the change in the control arm's position between the ride height D1 and the knelt height D2. This inherent motion generates lateral and torsional forces experienced by the chain 206 in the prior art system.

Kneeling system 200 may actuate between a riding height D1 as in FIG. 3 and a knelt height D2 as in FIG. 4. FIGS. 3 and 4 include a coordinate system referred to when describing the motion of the control arm 104 when it is actuated between ride height D1 and knelt height D2. The coordinates are defined such that the Y axis refers to front-to-back of the vehicle, the X axis refers to side-to-side of the vehicle, and the Z axis refers to the up and down of the vehicle. A comparison of FIGS. 3 and 4 shows that as the kneeling system 200 actuates between the riding height and the knelt height, the geometry of the control arm 104 causes the second end 105 to move along axis Z (up/down relative to the vehicle body), as labeled by coordinates in FIGS. 3 and 4. Because the control arm 104 is pivotably coupled at the first end 103 to the subframe 102, the second end 105 moves along an arcuate path as the control arm 104 rotates about the first end 103. Therefore, in addition to moving along the Z-axis, the second end 105 may also move along axis X (left/right relative to the vehicle body).

In addition to the second end 105 moving along the axis X, second end 105 may additionally move along axis Y (forward/rearward relative to the vehicle body), into and out of the plane of the drawings of FIGS. 3 and 4. This may be caused by the alignment of the control arm 104, which may not extend in a colinear X direction from the subframe 102. Instead, the control arm 104 may extend in both an X and Y direction from subframe 102. Alternatively or additionally to the control arm alignment, a pivot axis of the control arm 104 at first end 103 may not be parallel to the Y axis. This means that the second end 105 may move along the Y axis as the control arm 104 moves between the ride and knelt positions. The combined movement of the second end 105 along the X and Y axes may induce a lateral force on the chain 206, because the chain 206 attachment point to the control arm 104 moves through a three-dimensional arcuate path, while the pulley remains in a fixed position. This movement pulls the chain out of its ideal, straight alignment with the pulley, creating a force component perpendicular to the chain's intended direction of travel. Because roller chains are designed to articulate in only a single plane, these lateral forces induce significant stress and torsional loads which may eventually cause the chain 206 to prematurely fail.

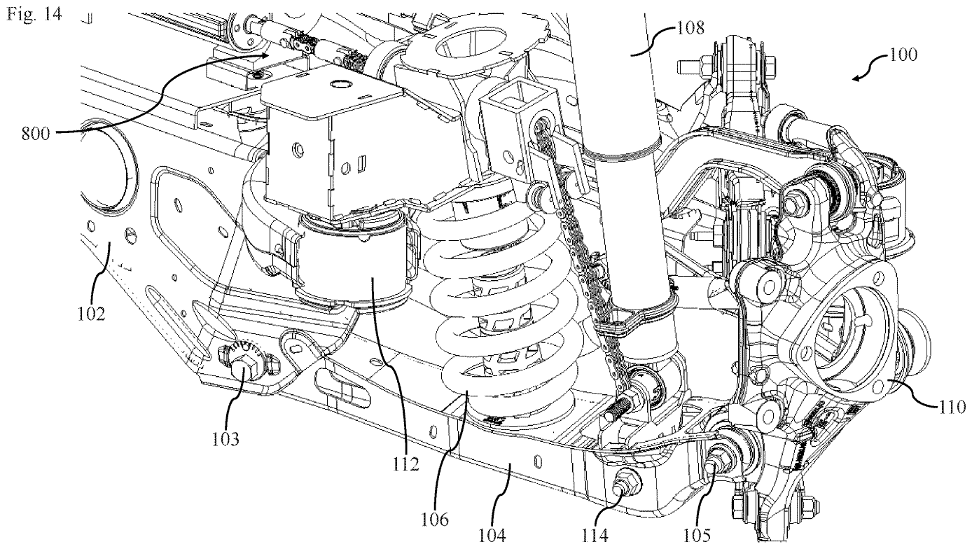

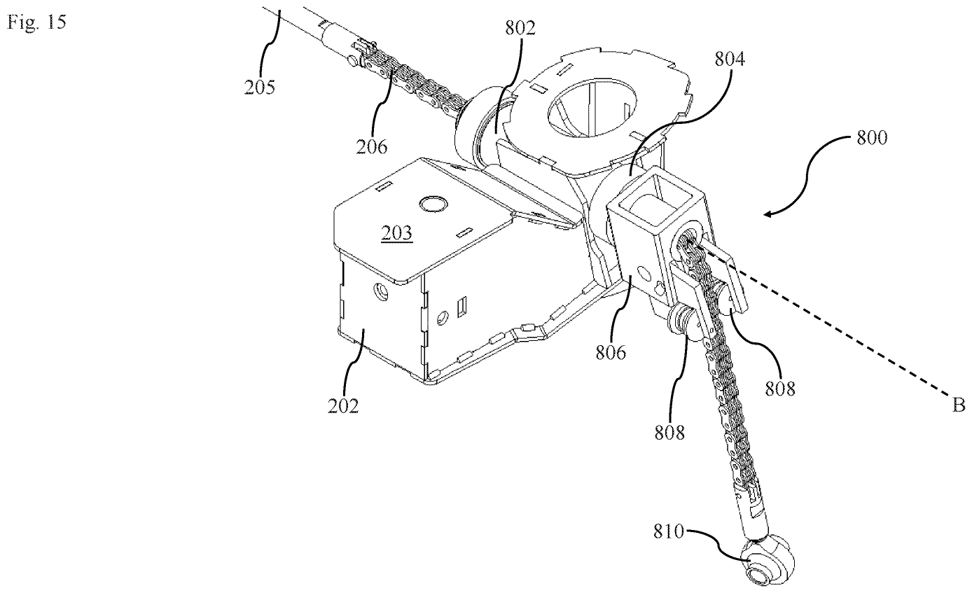

FIG. 14 illustrates a perspective view of a third new kneeling system 800 installed in an OEM suspension assembly 100. The new kneeling system 800 may be functionally similar to the prior art kneeling system 200, but with improvements for enhanced reliability. The fixed pulley 208 of the prior art kneeling system 200 may be replaced with a new pivoting pulley assembly. The kneeling system 800 and new pulley assembly are shown in FIG. 15, isolated from the OEM vehicle components for clarity.

In the new kneeling system 800, the body spacer 202 may have a tube 802. In some embodiments, the tube 802 may be fixedly coupled to the body spacer 202. The tube 802 may provide a path for the chain 206 to route through between the actuator and the connection to the control arm 104. A bearing may be configured to pivotably couple a bracket 806 to the tube 802, allowing the bracket 806 to pivot about a pivot axis B. The bracket 806 may have a pulley (not shown) housed within it to redirect the chain 206 from a substantially horizontal orientation to a substantially vertical orientation (relative to the vehicle body on level ground). In some embodiments, the pulley may be a grooved roller or sprocket configured to positively engage the tensile member (e.g., a chain) and maintain its alignment along the pulley's centerline. The bracket 806 may additionally have one or more guide rollers 808 configured to guide the substantially vertical portion of the chain 206. The guide rollers 808 are mounted elevationally lower than the pivot axis B such that the lateral force from the chain 206 may exert a torque on the bracket 806 via the guide rollers 808 when the kneeling system 800 is actuating and the second end 105 simultaneously moves along both the X and Y axes. This torque may be the driving force to induce pivoting of the bracket 806 about the pivot axis B. The pivoting of pulley about the axis B may induce a twisting on the horizontal portion of the chain 206 between the pulley and the moveable rod 205. The moveable rod 205 may be rotatable relative to a body of the actuator 200 to mitigate this twisting strain on the chain 206. It is further contemplated that the connection point between the chain 206 and moveable rod 205 may be freely rotating to mitigate the potential reaction twisting.

In alternative designs, it is contemplated that the guide rollers 808 may be replaced with an alternative low-resistance guide, such as a slide bearing like a low-friction plastic component. It is also contemplated that the rollers 808, or other replacement device as mentioned above, may be sufficiently rigid to transmit forces applied by the chain 206 to rotate the bracket 806.

The pivoting bracket 806 may reduce lateral forces on the chain 206, but may not fully mitigate the torsional forces experienced by the chain 206 as it twists about its own longitudinal axis. To help with the torsional forces, the connector 810 may be a heim joint, or a similar spherical bearing component, configured to connect the chain 206 to the control arm 104. The connector 810, being a spherical bearing, allows for multi-axis rotation, which may help reduce torsional forces on the chain 206 by allowing it to rotate freely.

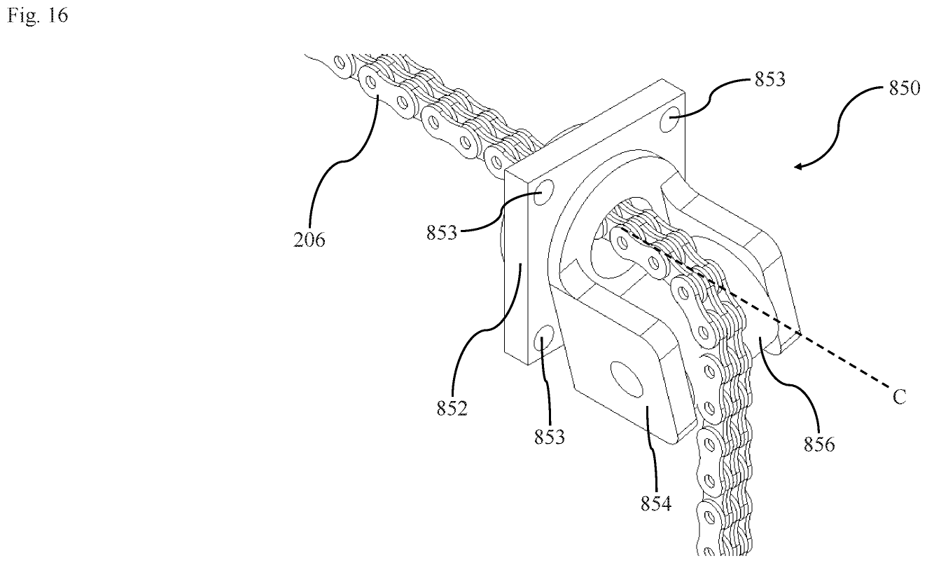

FIG. 16 illustrates a fourth new kneeling system, which may be a simplified version of the kneeling system 800 of FIGS. 14-15. Instead of a tube 802 fixed to the body spacer 202 and a complex pivoting pulley bracket 806, a pulley assembly 850 may have a mounting bracket 852 with a pivotably coupled bracket 854. A pulley 856 may be rotatably coupled to the bracket 854. The bracket 852 may have a plurality of apertures 853 for receiving a fastener to couple to the body spacer 202. As shown in FIG. 16, the features 853 may be apertures for receiving a fastener such as a bolt. It is alternatively contemplated that a fastener may be integrally formed into bracket 852, such as a threaded feature to receive a bolt like a tapped hole, weld-nut, RIV-nut, PEM-nut, or a threaded feature extending from bracket 852 like a PEM-stud, RIV-stud, weld stud, or other known fasteners.

Pulley assembly 850 may improve upon the pulley 208 rotatably coupled to body spacer 202 in prior art kneeling system 200. Instead of the pulley 208 being coupled to body spacer 202 in a fixed orientation, a pulley 856 may be rotatably coupled to a bracket 854. The bracket 854 may be pivotably coupled to the bracket 852 such that the bracket 854 and pulley 856 may rotate about an axis C. The pivotable connection between the bracket 854 and the bracket 852 coupled to body spacer 202 may help ease the reaction forces by the pulley 856 when the kneeling system is actuating between riding height and the knelt height and the displacement of the control arm 104 introduces a twisting force on the chain 206.

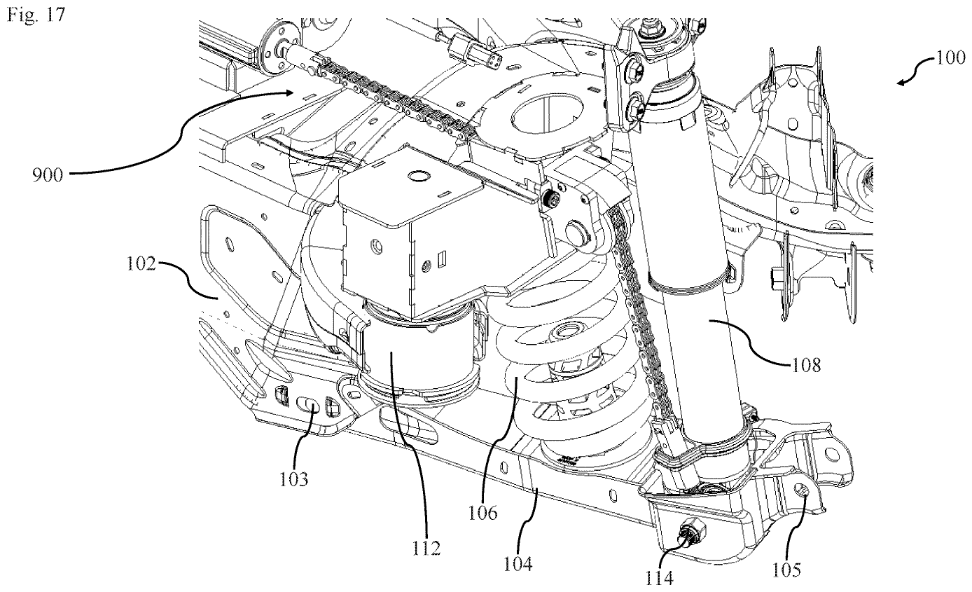

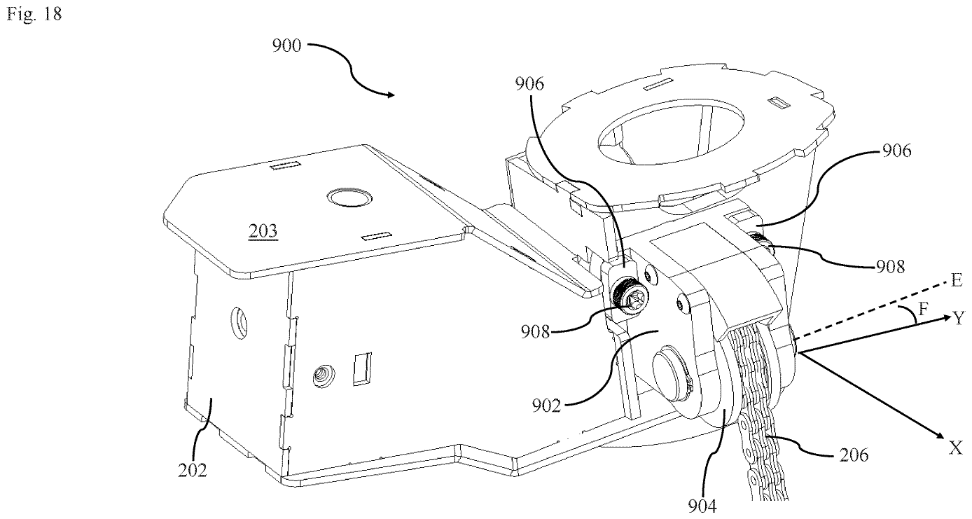

FIG. 17 illustrates a perspective view of a fifth new kneeling system 900 installed in an OEM suspension assembly 100. The new kneeling system 900 provides an intermediary design between prior art kneeling system 200 and the kneeling system 800. The pulley 208 of the prior art kneeling system 200 may have an axis of rotation oriented in a substantially horizontal position relative to the vehicle body. Specifically, the axis of rotation of the pulley 208 may be substantially parallel to the Y axis as defined relative to the vehicle body in FIGS. 3 and 4. The pulley 208 of the prior art kneeling system 200 may be replaced with a new pulley assembly. The kneeling system 900 and new pulley assembly are shown in FIG. 18, isolated from the OEM vehicle components for clarity.

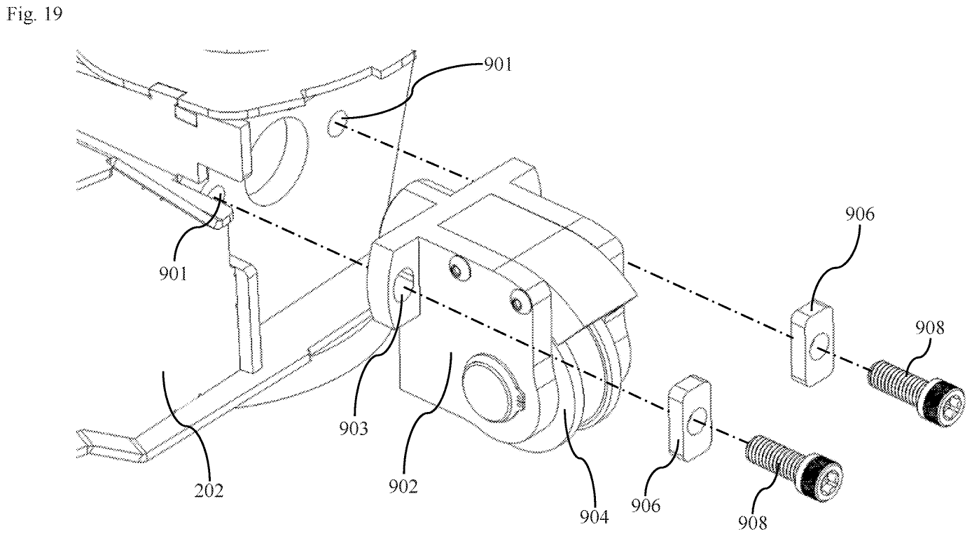

A bracket 902 may be provided to couple to body spacer 202 with fasteners 908. A clamping bracket 906 may be provided to couple between fasteners 908 and bracket 902 to distribute the force of the secured fasteners 908 on bracket 902. A pulley 904 may be rotatably coupled to the bracket 902. The construction of the new kneeling system 900 is further shown in detail in an assembly view in FIG. 19.

Bolts 908 may be threadingly fastened to holes 901, illustrated here as tapped holes. It is alternatively contemplated that a nut may be used on another side of the body spacer 202 to clamp bolts 908 to the body spacer 202. Alternatively, body spacer 202 may include weld nuts, RIV-nuts, or PEM-nuts. It is further contemplated that body spacer 202 may include a threaded feature extending from the body spacer 202 configured to go through the bracket 902 and clamp to a nut. The threaded feature may be a weld stud, RIV-stud, or PEM-stud. It is also contemplated that holes 901 may be through holes for bolts 908 and clamping brackets 906 may comprise a threaded hole for securing the assembly.

As illustrated in FIG. 19, the bracket 902 may have apertures 903 by which the bolts 908 may extend through in a fastened configuration. The apertures 903 may be elongated slots. Specifically, the elongated slots may be arcuate slots to promote rotatable positioning of the bracket 902 relative to the body spacer when securing to the body spacer 202. Since pulley 904 does not actively adjust position as in the embodiment of FIGS. 14-16 as the kneeling system adjusts between riding and knelt positions, slotted apertures 903 may provide adequate adjustment for bracket 902 to position the pulley 904 in a intermediate to accommodate any twisting of the chain 206 and thereby mitigate forces of torsion.

In one assembly method, it is contemplated that the kneeling assembly 900 may be installed on a vehicle such that bracket 902 is snugly, but not securely, attached to body spacer 202 with bolts 908. The kneeling system 900 may then be cycled a predetermined number of times with an actuator (not shown). The torsion forces on the chain 206 may exert a torque on pulley 904 and rotate bracket 902 relative to body spacer 202. Torsion forces on the chain 206 may exert a torque on the pulley 904, thereby rotating the bracket 902 into an aligned position. After completing the predetermined cycles, bolts 908 may be fully torqued down to secure bracket 902 in a fixed position. This adjustment during assembly may improve upon fixed pulley 208 as each vehicle may have slightly different requirements due to tolerance stack up in the various connections of the suspension system. Further, this method could be performed not only during the initial conversion, but also after a vehicle has been used in service or if it has had suspension service, such as an alignment.

It is alternatively contemplated that to save on installation time, the bracket 902 may be aligned with a tool or jig to position it correctly without the need for the time-consuming method of cycling the system for the bracket 902 to self-align. The jig may also improve the quality of the system and ensure the bracket 902 is aligned without potential for human error.

In an example of this installation method, a tool may be used to align the pulley 904. While a physical alignment tool, such as a mechanical pointer or a physical jig, could be used, such devices can be bulky and cumbersome. A more effective approach utilizes a light source for its simplicity, accuracy, and durability. In this installation method, the bracket 902, without pulley 904 rotatably coupled to the bracket 902, may be loosely coupled to the body spacer 202. A light source, such as a laser pointer may then be temporarily coupled to the bracket 902. The laser pointer may include a bracket for temporary affixing to the bracket 902. The bracket 902 may then be rotated until the laser points at a specified point on the control arm 104. Optionally, an alignment fixture, such as a target may be temporarily affixed to the control arm 104 to ensure the bracket 902 is aligned and pointing the laser at the exact required location.

In a further example of installation, the bracket 902 may be readjusted during service of the vehicle. Even in commonly designed vehicles, the adjustment of bracket 902 needed may vary due to tolerance stack-up during the OEM vehicle manufacturing, vehicle conversion process, or other factors. In addition, use of the vehicle may put wear into the suspension components, causing them to slightly change from their OEM positions. The adjustability of the bracket 902 provides adjustment for all scenarios to ensure reliability of the system, while accommodating external factors that may misalign the bracket 902.

The detailed description presented here captures the progression from traditional suspension systems, through prior art attempts, to the innovative solution claimed in the present invention. The integration of a robust rocker link 310 mechanism, and new flexible coupling options highlight the key components and interactions within the system, providing comprehensive coverage of the inventive concepts.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. An adjustable suspension system for a vehicle having a body, the adjustable suspension system comprising:
a subframe configured to be coupled to the body;
at least one control arm configured to be pivotably coupled to the subframe adjacent a first end of the control arm and coupled to a wheel adjacent a second end of the control arm;
at least one spring device coupled between the control arm and the body; and
a kneel system configured to be coupled between the control arm and the subframe, the kneel system comprising:
an actuator having a moveable element;
a tensile member, wherein a first end of the tensile member is coupled to the moveable element and a second end of the tensile member is coupled to the control arm; and
a pulley assembly coupled to a fixed structure of the vehicle, the pulley assembly configured to guide the tensile member between the actuator and the control arm, the pulley assembly comprising:
a bracket configured to be coupled to the fixed structure; and
a pulley rotatably coupled to the bracket, wherein the pulley engages the tensile member;
wherein the bracket is pivotably coupled to the fixed structure such that the pulley can rotate relative to the fixed structure.

2. The adjustable suspension system of claim 1, wherein the bracket is rotatably coupled to the fixed structure via a bearing, such that the pulley can freely rotate.

3. The adjustable suspension system of claim 1 wherein the bracket defines at least one elongated slot configured to receive a fastener for coupling the bracket to the fixed structure, whereby the elongated slot permits rotational adjustment of the bracket about the axis relative to the fixed structure to align the pulley with the tensile member, after which the fastener is securable to fix the bracket in an adjusted rotational position.

4. The adjustable suspension system of claim 3, wherein the tensile member is a roller chain.

5. The adjustable suspension system of claim 1, wherein the fixed structure is an aftermarket body spacer configured to be coupled between the body and the subframe of the vehicle to raise the body from an OEM height to a modified height.

6. The adjustable suspension system of claim 1, wherein the actuator is a linear actuator and the moveable element is an extendable rod of the actuator configured to movably extend and configured to couple to a first end of the tensile member.

7. The adjustable suspension system of claim 1, wherein the at least one control arm is a lower control arm.

8. The adjustable suspension system of claim 3, wherein the at least one elongated slot is an arcuate slot.

9. The adjustable suspension system of claim 8, wherein the at least one elongated slot comprises two elongated slots, and wherein the kneel system comprises two fasteners, each fastener configured to be received by one of the two elongated slots.

10. The adjustable suspension system of claim 3, further comprising at least one clamping bracket disposed between the fastener and the bracket, wherein the clamping bracket is configured to distribute a clamping force from the fastener onto the bracket.

11. A method of modifying a vehicle having a body, a subframe coupled to the body, at least one control arm configured to be pivotably coupled to the subframe adjacent a first end of the control arm and coupled to a wheel adjacent a second end of the control arm, at least one spring device coupled between the control arm and the body, and a body spacer between the subframe and the body, the vehicle being configured to receive an actuator having a moveable element and a tensile member being configured for coupling between the moveable element and the control arm, the method comprising the steps of:
loosening a fastener that couples a bracket to the body spacer or applying the fastener to loosely couple the bracket to the body spacer, wherein the bracket comprises a pulley rotatably coupled to the bracket, the pulley being configured to redirect the tensile member between the moveable element and the control arm;
coupling a light source to the bracket;
rotating the bracket until the light source points at a specified point on the control arm;
removing the light source from the bracket; and,
tightening the fastener to securely couple the bracket to the body spacer.

12. The method of claim 11, further comprising the step of coupling a target to the control arm to further align the light source when rotating the bracket.

13. The method of claim 12, wherein the light source is a laser.

14. The method of claim 11, wherein the tensile member is a roller chain.

15. The method of claim 11, wherein the bracket comprises one or more elongated slots for rotating the bracket.

16. The method of claim 15, further comprising the step of installing a clamping bracket between the fastener and the elongated slot of the rotating bracket.

17. A method of modifying a vehicle having a body, a subframe coupled to the body, at least one control arm configured to be pivotably coupled to the subframe adjacent a first end of the control arm and coupled to a wheel adjacent a second end of the control arm, at least one spring device coupled between the control arm and the body, and a body spacer between the subframe and the body, the vehicle being configured to receive an actuator having a moveable element and a tensile member being configured for coupling between the moveable element and the control arm, the method comprising the steps of:
loosening a fastener that couples a bracket to the body spacer or applying the fastener to loosely couple the bracket to the body spacer, wherein the bracket comprises a pulley rotatably coupled to the bracket, the pulley being configured to redirect the tensile member between the moveable element and the control arm;
cycling the actuator to retract and release the tensile member to retract and release the control arm, wherein a force experienced by the tensile member during cycling transfers the force to the pulley and rotates the bracket relative to the body spacer; and,
tightening the fasteners to securely couple the bracket to the body spacer.

18. The method of claim 17, wherein the bracket comprises at least one elongated slots for rotating the bracket.

19. The method of claim 17, further comprising the step of installing a clamping bracket between the fastener and the at least one elongated slot of the rotating bracket.

20. The method of claim 17, wherein when the bracket is securely coupled to the body spacer, the pulley rotatably coupled to the bracket has a rotation axis that is oblique to a longitudinal axis of the vehicle.
